(19) United States
(12) Patent Application Publication
(10) Pub. No.: US 2012/0127970 A1
(43) Pub. Date: May 24, 2012

(54) Wireless Network System And Method Configured To Mitigate Co-channel Interference

(76) Inventors: Anil Gupta, Shrewsbury, MA (US); Vincent Ma, Shrewsbury, MA (US); Sung-Ju Lee, San Francisco, CA (US); Jung Gun Lee, Palo alto, CA (US)

(21) Appl. No.: 13/387,467

(22) PCT Filed: Jan. 29, 2010
(86) PCT No.: PCT/US10/22527

§ 371 Date: Jan. 27, 2012

(51) Int. Cl. H04B 15/00; H04J 3/00; H04W 72/04; H04B 7/24

(52) U.S. Cl. 370/336

(57) ABSTRACT

One embodiment provides a wireless network system (10) configured to mitigate co-channel interference. The system comprises a plurality of coverage cells (42,62) arranged to form a communication cluster (40, 60) and a plurality of communication channels (A, B, C) assigned to the plurality of coverage cells to define a plurality of different same channel sets of coverage cells for each communication channel of the plurality of communication channels. Different same channel sets of coverage cells are configured to communicate during different transmission time periods to mitigate co-channel interference.

### BACKGROUND

In large wireless networks, there are multiple wireless coverage cells. Coverage cells proximate to one another can interfere with each other if they operate on the same channel, referred to as co-channel interference. Channel assignment algorithms allocate different channels to different cells in proximity to avoid interference between the cells. However, when the number of non-overlapping channels is small compared to the number of cells that are within the interference region of each other, a transmission from one cell can interfere and collide with a transmission from other cell(s) resulting in poor performance.

### BRIEF DESCRIPTION OF THE DRAWINGS

FIG. 1 depicts a block diagram of an example embodiment of a portion of a wireless network system that can be arranged into coverage cells to form a communication cluster.

FIG. 2 illustrates an example embodiment of a wireless network system arranged in a communication cluster with a first set of coverage cells configured to transmit during a first transmission time period.

FIG. 3 illustrates an example embodiment of the wireless network system of FIG. 2 with a second set of coverage cells configured to transmit during a second transmission time period.

FIG. 4 illustrates another example embodiment of a wireless network system arranged in a communication cluster employing two channels with a first set of coverage cells configured to transmit during a first transmission time period.

FIG. 5 illustrates an example embodiment of the wireless network system of FIG. 4 with a second set of coverage cells configured to transmit during a second transmission time period.

FIG. 6 depicts an example embodiment of a method for configuring a wireless network system.

### DETAILED DESCRIPTION

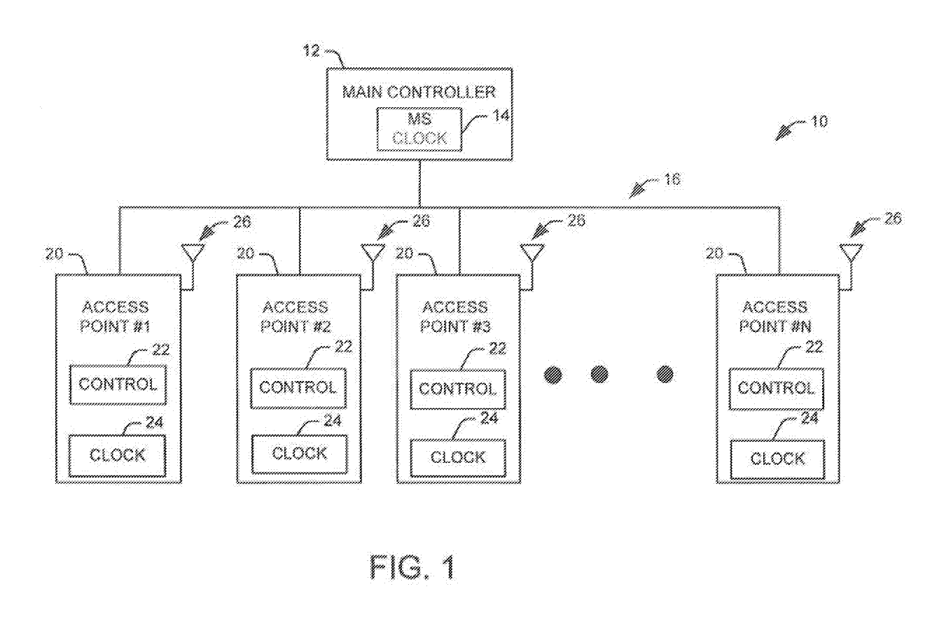

FIG. 1 illustrates a block diagram of an example of a portion of a wireless network system 10 that can be arranged into coverage cells to form a communication cluster. A communication cluster is a plurality of generally nonoverlapping coverage cells arranged in a plurality of columns and rows. A coverage cell is a defined communication coverage area provided by at least one access point. The portion of the wireless network system 10 includes a main controller 12 coupled to a plurality of access points 20 labeled #1-N, where N is a positive integer denoting the number of access points (N>1) and thus the number of coverage cells, over a network backbone 16. The network backbone 16 can be wired or wireless. A given access point 20 includes a control portion 22 and a clock 24 that controls the transmission and synchronization of communications to and from the access point 20 over an antenna 26 to one or more client communication units (CCUs) (not shown). The control portion 22 can include one or more processors, memory and other circuitry for configuring the access point 20 to communicate over an assigned channel and during assigned transmission time periods. A given access point 20 can be a server communication unit (SCU) for a given coverage cell.

For example, a first access point can be assigned to communicate over assigned channel A in a first coverage cell and be assigned to communicate with multiple CCUs in the first coverage cell during different transmission time periods via time division multiple access (TDMA) based polling within the first coverage cell to avoid interference between CCUs in the first coverage cell. A second access point can be also assigned to communicate over assigned channel A in a second coverage cell and be assigned to communicate with multiple CCUs in the second coverage cell during different transmission time periods via TDMA based polling within the second coverage cell to avoid interference between CCUs in the second coverage cell.

Furthermore, if the first coverage cell interferes with the second coverage cell, then the first and second access points can be configured to communicate over different nonoverlapping transmission time periods via TDMA hierarchical polling across coverage cells. This technique can be employed across an entire cluster of coverage cells to mitigate co-channel interference with coverage cells that employ the same channel. The clock 24 of each access point 20 will be synchronized to a master clock 14 associated with the main controller 12. The access points 20 can be preconfigured to communicate over an assigned channel and assigned time periods prior to arranging in a communication cluster or be programmed after being arranged in a communication cluster.

It is to be appreciated that an interference algorithm can be employed in a communication cluster to determine interference between cells transmitting over a same channel and an appropriate interference free distance. The results in the algorithm can be employed to determine a number of sets of same channel coverage cells assigned different transmission time periods and the distance between same channel coverage cells in the same set (e.g., one coverage cell, two coverage cells away, three coverage cells away, etc.).

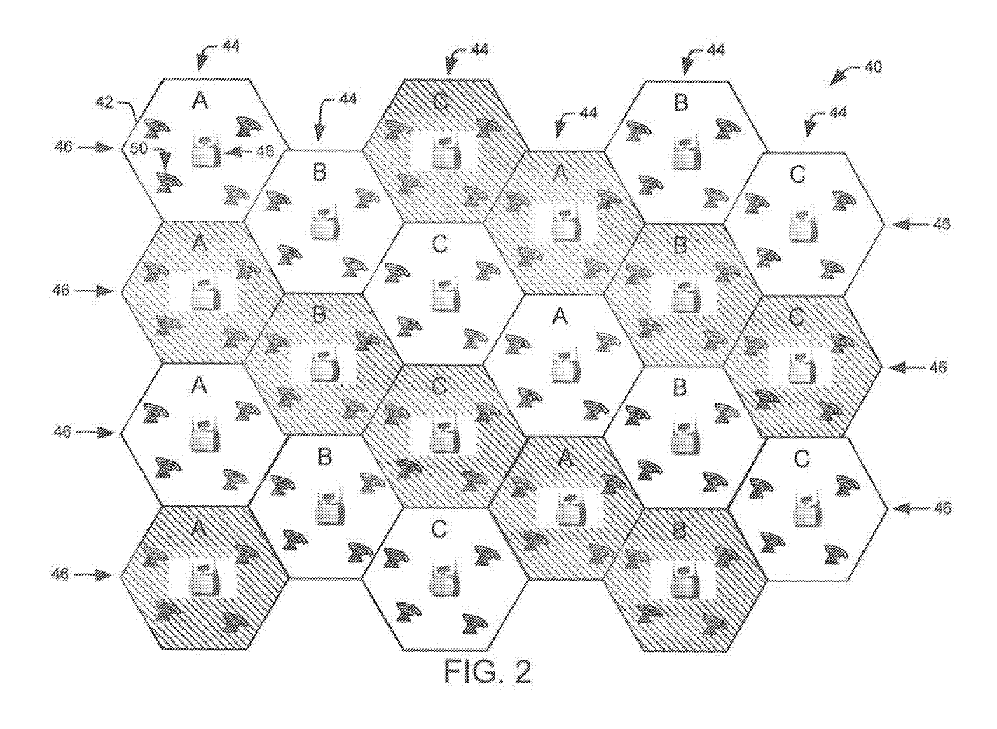

FIGS. 2-5 illustrate clusters as a plurality of coverage cells arranged as a hexagonal coverage cell layout of columns and rows. As is known, depicting the geographical service area in terms of a hexagonal cell layout establishes a geometric pattern that permits frequencies to be assigned in a patterned disposition allowing the reuse of those frequencies in a controlled repeatable regular assignment model. In the model, cells marked “A” are co-user coverage cells and all use the same channel. The same is true for co-user coverage cells marked “B” and “C”, each of which has its own assigned channel. It should be understood that the hexagonal shape of the coverage cells represents a drawing convention. Such a hexagonal cell representation has been chosen because it approaches a circular shape that is the ideal power coverage cell for a coverage cell. However, use of such circular shapes would involve overlapped areas and make a drawing of the served area unclear. With the hexagonal shaped coverage cell convention, on the other hand, the plurality of coverage cells representing a service area can be depicted with no gap and no overlap between cells. Columns are illustrated as contiguous coverage cells, while rows are illustrated as non-contiguous coverage cells. However, it is to be appreciated that rows could also be contiguous in an actual communication cluster. It is to be appreciated that the term columns and rows can be interchangeable based the orientation of the view of the communication cluster 40.

FIG. 2 illustrates an example of a wireless network system arranged in a communication cluster 40 with a first set of coverage cells configured to transmit during a first transmission time period. The communication cluster 40 is formed of a plurality of columns 44 and rows 46 of generally non-overlapping coverage cells 42 and includes a first set of coverage cells without hash marks configured to transmit during a first transmission time period and a second set of coverage cells with hash marks configured to be silent during the first transmission time period. Each coverage cell 42 includes at least one access point 48 configured to communicate with one or more CCUs 50 within the coverage cell over an assigned channel and an over assigned transmission time periods. The example of FIG. 2 illustrates two sets of coverage cells transmitting over different time periods, but could include more sets of coverage cells transmitting over more than two time periods based on interference results and a determined interference free distance between coverage cells assigned the same channel. In some cases, the interference free distance can be the same as the number of channels employed in the wireless network system.

As illustrated in FIG. 2, the communication cluster 40 is configured with linear channel assignments with six columns being illustrated with coverage cells in the first and fourth columns being assigned channel A, coverage cells in the second and fifth columns being assigned channel B, and coverage cells in the third and sixth column being assigned channel C. In this manner, different nonoverlapping channels are assigned to different columns in an interleaving pattern, which repeats itself over the communication cluster 40. It is to be appreciated that six columns of the communication cluster 40 are provided for illustrated purposes and a communication cluster can be formed of more or less columns. Three different channels are shown for illustrative purposes, however, more or less channels could be employed throughout the communication cluster 40.

As further illustrated in FIG. 2, communication units in a first set of coverage cells without hash marks have been assigned to transmit during a first transmission time period while communication units in a second set of coverage cells with hash marks have been assigned to be silent during the first transmission time period. In this manner, communication units in coverage cells assigned the same channel and column and/or the same channel and row are assigned to either transmit or be silent during a first transmission time period in an interleaving pattern such that communication units assigned to transmit during the first transmission time period are in coverage cells that are adjacent to coverage cells with communication units assigned to not transmit during the first transmission time period to mitigate co-channel interference.

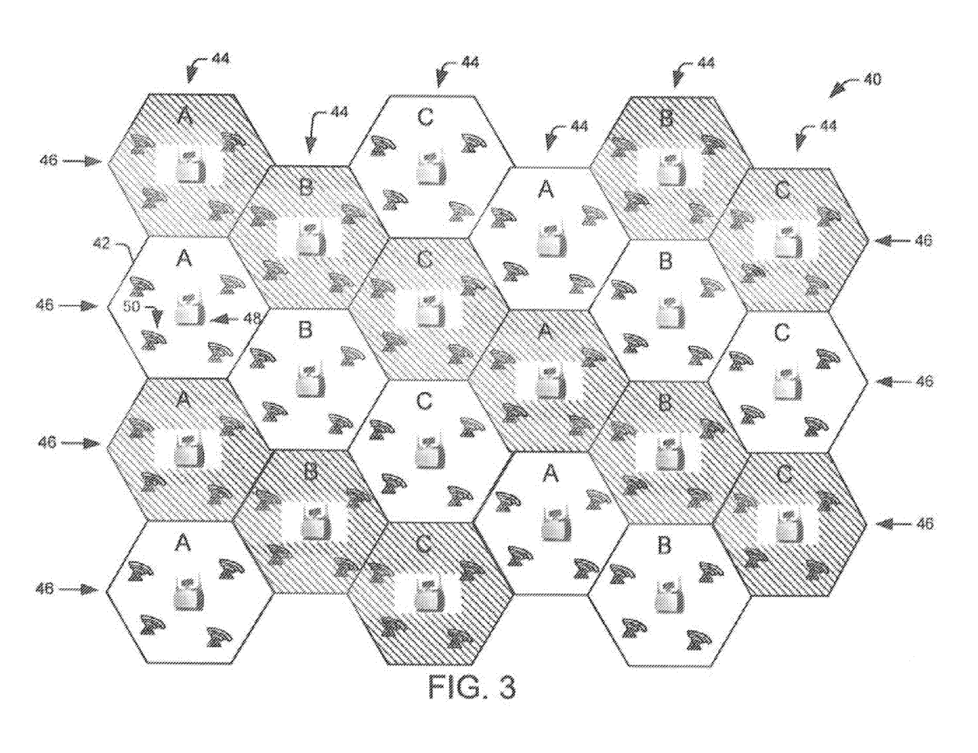

FIG. 3 illustrates an example of the wireless network system 40 of FIG. 2 with a second set of coverage cells configured to transmit during a second transmission time period. During the second transmission time period, communication units in the first set of coverage cells 42 with hash marks assigned the same channel and column and/or same channel and row that were transmitting during the first transmission time period have been assigned to be silent during the second transmission time period. Communication units in the second set of coverage cells 42 without hash marks assigned the same channel and column and/or same channel and row that were not transmitting during the first transmission time period are assigned to communicate during the second transmission time period. The communication units in adjacent coverage cells 42 in a given column 44 and/or given row 46 can alternate between transmission and silent time periods in a cross cell hierarchical TDMA based polling scheme. The channel and transmission time period arrangement of FIG. 2 and FIG. 3 mitigate co-channel interference since communication units employing the same channel in adjacent coverage cells transmit in alternating transmission time periods.

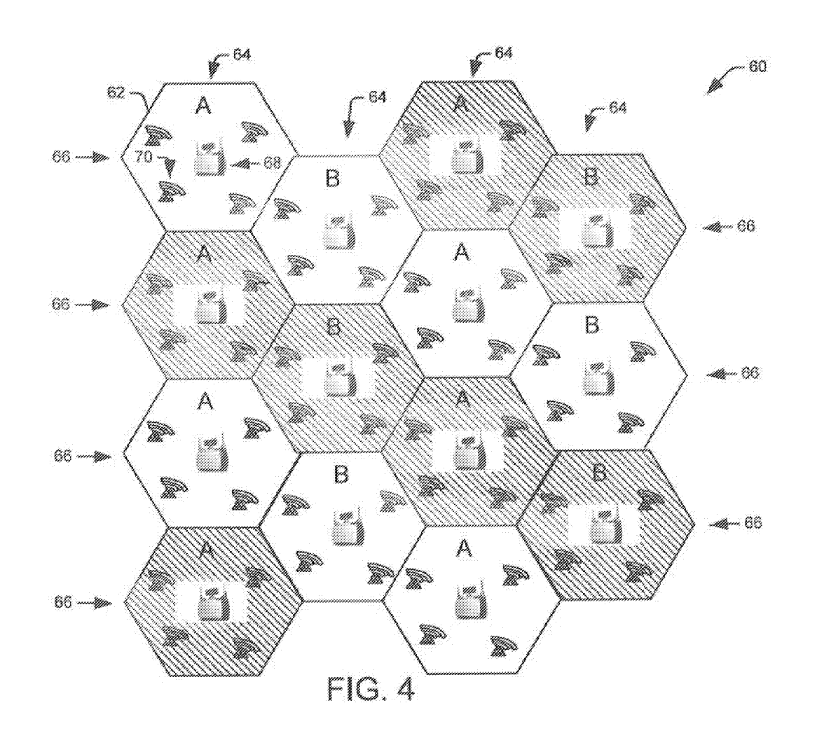

FIG. 4 illustrates another example of a wireless network system arranged in a communication cluster 60 employing two channels with a first set of coverage cells configured to transmit during a first transmission time period. The communication cluster 60 is formed of a plurality of columns 64 and rows 66 of generally non-overlapping coverage cells 62. Each coverage cell 62 includes at least one access point 68 configured to communicate with one or more CCUs 70 within the coverage cell 62 over an assigned channel and an over assigned transmission time periods. In the model shown in FIG. 4, cells marked “A” are co-user cells and all use the same channel and cells marked “B” are co-user cells and all use the same channel.

As illustrated in FIG. 4, the communication cluster 60 is configured with linear channel assignment with four columns 64 being illustrated with coverage cells 62 in the first and third columns being assigned channel A and coverage cells 62 in the second and fourth columns being assigned channel B. In this manner, channel A and B are assigned to columns in an interleaving pattern, which repeats itself over the communication cluster. It is to be appreciated that four columns of the cluster are provided for illustrated purposes and a cluster can be formed of more or less columns.

As further illustrated in FIG. 4, communication units in a first set of coverage cells 62 without hash marks have been assigned to transmit during a first transmission time period while communication units in a second set of coverage cells 62 with hash marks have been assigned to be silent during the first transmission time period. In this manner, communication units in coverage cells assigned the same channel and column and/or same channel and row are assigned to either transmit or be silent during a first transmission time period in an interleaving pattern such that communication units assigned to transmit during the first transmission time period are in coverage cells that are adjacent to coverage cells with communication units assigned to not transmit during the first transmission time period to mitigate co-channel interference.

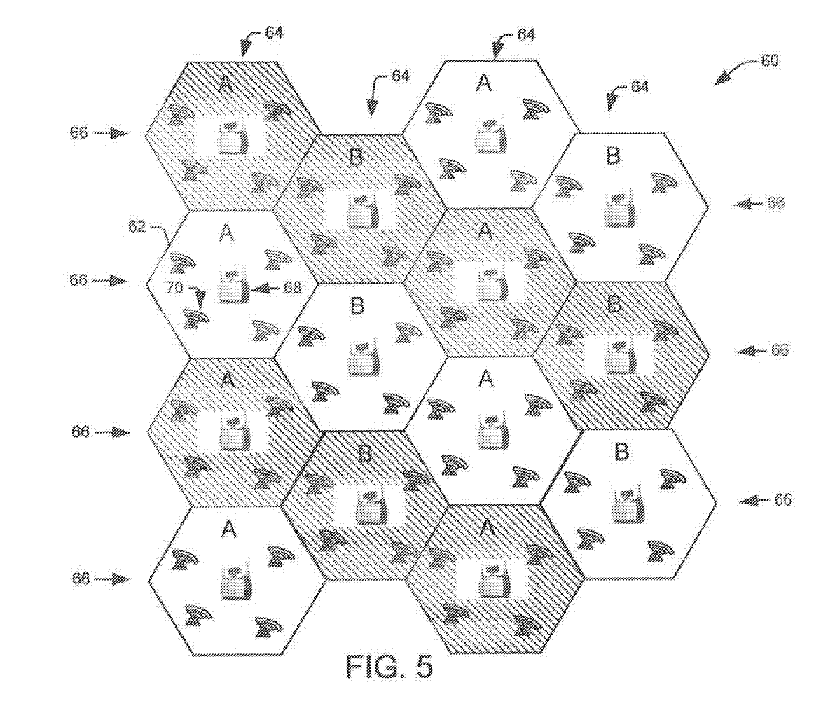

FIG. 5 illustrates an example of the wireless network system of FIG. 4 during a second transmission time period. During the second transmission time period, communication units in coverage cells with hash marks assigned the same channels that were transmitting during the first transmission lime period have been assigned to be silent during the second transmission time period. Communication units in coverage cells without hash marks assigned the same channels that were not transmitting during the first transmission time period are assigned to communicate during the second transmission time period. The communication units in adjacent coverage cells transmitting over a same channel in a given column can alternate between transmission and silent time periods in a cross cell hierarchical TDMA based polling scheme. Furthermore, since there are only two channels, the communication units in adjacent coverage cells in a given row can alternate between transmission and silent time periods in a cross cell hierarchical TDMA based polling scheme. The channel and transmission time assignment arrangement of FIG. 4 and FIG. 5 mitigate co-channel interference since communication units employing similar channels in adjacent coverage cells transmit in alternating transmission time periods.

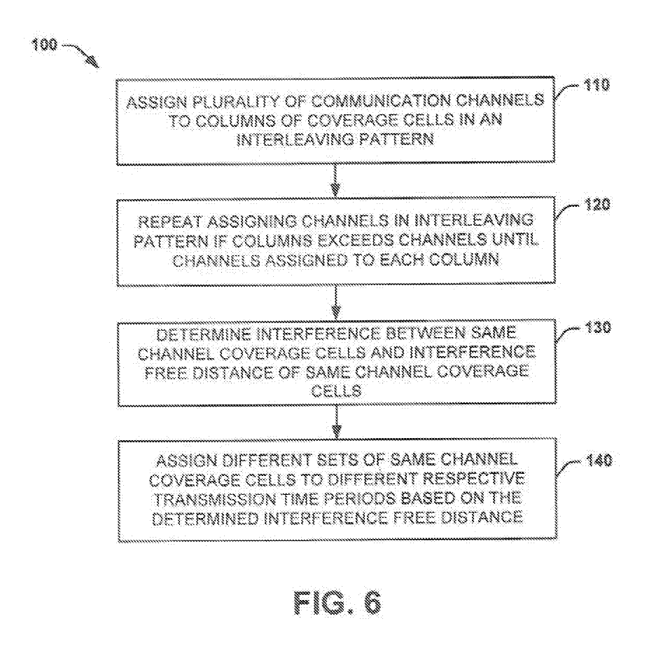

In view of the foregoing structural and functional features described above, certain methods will be better appreciated with reference to FIG. 6. It is to be understood and appreciated that the illustrated actions, in other embodiments, may occur in different orders and/or concurrently with other actions. Moreover, not all illustrated features may be required to implement a method.

FIG. 6 depicts an example embodiment of a method 100 for configuring a wireless network. At 110, a plurality of communication channels are assigned to different coverage cells such that a given communication channel is assigned to each coverage cell in a column of coverage cells with different channels of the plurality of communication channels being assigned to different columns of coverage cells in an interleaving pattern. At 120, the assigning of channels to columns in an interleaving pattern is repeated if the number of columns exceeds the number of channels until channels are assigned to coverage cells for each column in the communication cluster. At 130, interference between same channel coverage cells and an interference free distance for same channel coverage cells are determined. At 140, different sets of same channel coverage cells are assigned to different respective transmission time periods based on the determined interference free distance.

What has been described above are example embodiments of the disclosure. It is, of course, not possible to describe every conceivable embodiment of the invention, but one of ordinary skill in the art wilt recognize that other embodiments are possible. Accordingly, this disclosure is intended to embrace all embodiments alterations, modifications, and variations that fall within the scope of the appended claims.

What is claimed is:

1. A wireless network system (10) configured to mitigate co-channel interference, the system comprising:
a plurality of coverage cells (42, 62) arranged to form a communication cluster (40);
a plurality of communication channels (A, B, C) assigned to the plurality of coverage cells to define a plurality of different same channel sets of coverage cells for each communication channel of the plurality of communication channels; and
wherein different same channel sets of coverage cells are configured to communicate during different transmission time periods to mitigate co-channel interference.

2. The system of claim 1, wherein the plurality of coverage cells are arranged in columns (44, 64) of coverage cells and each coverage cell in a column is assigned a same respective channel with different channels of the plurality of communication channels being assigned to different columns of coverage cells in an interleaving pattern.

3. The system of claim 2, wherein coverage cells of a first set of coverage cells of a same respective channel and column are configured to communicate during a first transmission time period and be silent during a second transmission time period and communication units within a second set of coverage cells of the same respective channel and column are configured to communicate during the second transmission time period and be silent during the first transmission time period.

4. The system of claim 3, wherein the plurality of coverage cells are arranged in rows (46, 66) of coverage cells and coverage cells of a third set of coverage cells of a same respective row and column are configured to communicate during the first transmission time period and be silent during the second transmission time period and communication units within a fourth set of coverage cells of the same respective row and column are configured to communicate during the second transmission time period and be silent during the first transmission time period.

5. The system of claim 2, wherein the assigning of channels to columns in an interleaving pattern is repeated if the number of columns exceeds the number of channels until channels are assigned to coverage cells for each column in the communication cluster.

6. The system of claim 1, wherein each of the plurality of coverage cells is assigned at least one access point (20, 48, 68).

7. The system of claim 6, wherein each of the at least one access points of the plurality of coverage cells has a clock (24) that is synchronized to a master clock (14) to allow for control of the communications during the different transmission time periods.

8. The system of claim 6, wherein the at least one access point of at least one coverage cell is configured to employ time division multiple access (TDMA) polling with client communication units (CCUs) (50, 70) within its respective coverage cell.

9. The system of claim 6, wherein each of the at least one access points of the plurality of coverage cells is configured to employ time division multiple access (TDMA) polling across coverage cells to mitigate co-channel interference.

10. A wireless network system (10) comprising:
a plurality of coverage cells (42, 70) arranged in a plurality of columns (44, 64) and rows (46, 66) to form a communication cluster (40, 60), a given coverage cell of the plurality of coverage cells having at least one access point (20, 48, 68) that controls communications with client communication units (CCUs) (50, 70) within the given coverage cell;
a plurality of communication channels such that a given communication channel is assigned to each coverage cell in a column of coverage cells with different channels of the plurality of communication channels being assigned to different columns of coverage cells in an interleaving pattern; and
access points within a first set of coverage cells in a respective column are configured to poll CCUs during a first transmission time period and be silent during a second transmission time period and access points within a second set of coverage cells in the respective column are configured to poll CCUs during the second transmission time period and be silent during the first transmission time period to mitigate co-channel interference.

11. The system of claim 10, wherein access points within a third set of coverage cells of a same respective channel and row are configured to poll CCUs during the first transmission time period and be silent during the second transmission time period and access points within a fourth set of coverage cells in the same respective channel and row are configured to poll during the second transmission time period and be silent during the first transmission time period.

12. The system of claim 11, wherein coverage cells of the first set of coverage cells are adjacent coverage cells of the second set of coverage cells and the coverage cells of the third set of coverage cells are adjacent coverage cells of the fourth set of coverage cells.

13. A method (100) for configuring a wireless network system, the method comprising:
arranging a plurality of generally non-overlapping coverage cells in a plurality of columns and rows to form a communication cluster;
assigning a plurality of communication channels to different coverage cells such that a given communication channel is assigned to each coverage cell in a column of coverage cells with different channels of the plurality of communication channels being assigned to different columns of coverage tolls in an interleaving pattern (110); and
assigning different sets of same channel coverage cells to different respective transmission lime periods to mitigate co-channel interference (140).

14. The method of claim 13, further comprising repeating the assigning of channels to columns in an interleaving pattern if the number of columns exceeds the number of channels until channels are assigned to coverage cells for each column in the communication cluster (120).

15. The method of claim 14, further comprising determining an interference free distance for same channel coverage cells and wherein the assigning different sets of same channel coverage cells to different respective transmission time periods is based on the determined interference free distance (130).
